(19) United States
(12) Patent Application Publication
(10) Pub. No.: US 2017/0064924 A1
(43) Pub. Date: Mar. 9, 2017

(54) Animal Olfaction Training Apparatus and Method

(71) Applicant: Alison A. Stout, Redmond, WA (US)

(72) Inventor: Alison A. Stout, Redmond, WA (US)

(21) Appl. No.: 14/846,766

(22) Filed: Sep. 5, 2015

(51) Int. Cl. A01K 15/02; B05B 9/04

(52) U.S. Cl. CPC A01K 15/02; A01K 15/021; B05B 9/0426

(57) ABSTRACT

A training system including an apparatus and method for delivering an olfactory stimulus to an animal, comprising: one or more supply reservoirs having a sealable opening containing a reinforcing olfactant for eliciting a positive response in the animal, a release control in communication with the supply reservoir for regulating release of the reinforcing olfactant, a delivery channel connected to the supply reservoir for delivering the reinforcing olfactant released from the supply reservoir; and a housing wherein the one or more supply reservoirs and the delivery channel are mounted so as to orient the reinforcing olfactant sufficiently proximate to the animal to thereby stimulate olfaction.

### BACKGROUND OF THE INVENTION

1. Field of the Invention

The field of the invention relates to an animal training apparatus and method employing reinforcing olfaction to elicit a positive response from an animal.

2. Description of the Related Art

Since Pavlov's observations of classical conditioning and Skinner's studies of operant conditioning on the behavior of animals, animal training regimes have widely employed such behavioral conditioning techniques employing unpleasant “penalties” to discourage undesirable behavior and rewards to elicit desirable behavior. Known animal training regimes, focusing on horses and dogs, commonly employ food as rewards and unpleasant sensations, such as, for example, loud noises or physical striking of an animal, as punishments following a particular behavior. A prevalent use of positive reinforcement entails feeding an animal a favorite food after it heeds a command. For example, conventional dog training techniques employ dispensing a favorite treat following commands such as, for example, “heel,” “sit,” “lay down,” and “roll over.” Exemplary horse training regimes similarly employ food rewards to elicit gaits, postures, or competitive maneuvers, such as prancing or bowing, in response to verbal and physical contacts or corresponding commands. In order to facilitate concurrent or immediate dispensing of edible rewards following a command response while a trainer rides on its back, an apparatus for dispensing a desirable food through a tube fastened to the harness has been provided in the prior art.

However, edible rewards have many drawbacks. Many edible rewards are low in nutrition and high in calories derived from carbohydrates, such as, for example, fatty dog treats and sugary horse favorites. Such high calorie, carbohydrate-rich and fatty foods are difficult for digestive systems, joints and the endocrine system. In many animals, commonly used treats are specifically contraindicated, such as when animals are afflicted with digestive ailments, such as, gastroenteritis, colitis, constipation, diarrhea, pancreatitis, and malabsorption, or endocrinologic disorders such as insulin resistance. Another drawback of sugary edible rewards high in simple carbohydrates is the dental disease they cause, which is a particular problem of many older animals. Additionally, it may be difficult to “wean” the animal from requiring the edible reward in order to exhibit the desired behavior, thereby yielding a dependency on an unhealthy reward. An edible reward distracts from the training session and diverts the animal's attention toward obtaining food. For animals, food often symbolizes power. In fact, many animal trainers do not believe in using edible rewards because the act of giving up food is a submissive behavior and may detract from the role of the trainer as the leader.

A reinforcing substance availing the potency of an animal's olfactory senses could provide such an advantageous training technique. The olfactory senses of animals—the neurochemical response evoked when odors stimulate the brain cortex and amygdala to evoke positive or negative emotional and physical responses—are generally known to be highly developed. Exemplifying the olfactory acuity of animals, a dog can detect odorant concentrations of 1-2 parts per million. Notwithstanding such susceptibility of animals to olfaction, conventional methods have not employed that powerful sense to train or elicit positive responses in animals.

In the past, use of non-edible reinforcement animal training regimes has employed unpleasant and often painful punishments to modify animal behavior. For example, U.S. Pat. No. 8,091,512 applies an unpleasant spray deterrent and vibration directed to a dog's face and neck to prevent barking. Although the spray has an olfaction component, it also provides a physical deterrent as the spray is directed at the animal. Both the physical and olfaction components are used as a punishment and have limited impact and utility. The use of unpleasant substances (such as pepper spray) can impose pain and anxiety on the animal. Additionally, in prior art, U.S. Pat. No. 6,079,367 employs electrical aversive stimulus to punish and thereby stop a dog from leaving a circumscribed area. Similarly, shock collars are used as a training device to directly punish unwanted behavior. This prior art employs the use of the auditory and vibratory cues as a warning or prelude to the electrical shock. Thereby, the vibratory and auditory stimuli become negative stimuli as well. Such punishments are detrimental to the animal's state of mind and physiologic health. A further detriment of such and other use of aversive stimulus is the fear and distrust such tactics engender and consequent eroding of an animal's attitudes towards humans in general and relationship with the trainer in particular. Moreover, punishments and training by fear and pain are less efficacious than rewards, which inspire and motivate the animal to act.

An olfactory substance has limitless potential for use in working animals as a command in addition to use as a reward to reinforce behavior. A particular drawback limiting the duration of the efficacy of an olfactant in treating or caring for animals would be an animal's desensitization when continuously exposed an olfactory substance. Continued exposure to an odor diminishing the impact of olfaction over time is referred to as habituation. Habituation diminishes an animal's ability to distinguish between odors is diminished with exposure resulting from the reduction of stimulus to the brain of a continuous odor. Thus, habituation imposes significant limitations on the efficacy of training techniques employing a single olfactant, or direct application of an olfactant on an animal's skin, hair or other organ.

It would, therefore, be advantageous to provide reinforcing substances forming positive, quick, and preferably immediate, and strong associations with behavior in order to achieve effective, long lasting behavior modification and commands while preserving animal welfare. It would also be advantageous to substantially reduce the total time required to fully train animals, including horses, for a specific activity by use of such potent agents. Finally, it would be advantageous to reduce the consumption of unhealthy edible rewards in training animals such as dogs and horses, by using an olfactory reinforcement training and command method and apparatus, in order to achieve effective, long-lasting health and positive behavior, including instilling a desired mood or cueing a desired behavior.

In the past, the prior art has not provided a training regime to address the aforementioned and other drawbacks of the prior art and to provide such advantages. As a result, there persists a need for a training system employing a rapidly assimilated response while avoiding untoward health effects and retaining efficacy over time.

### SUMMARY OF THE INVENTION

Addressing such and other disadvantages of the prior art, the present invention provides a training system including an apparatus and method for delivering an olfactory stimulus to an animal, comprising: one or more supply reservoirs having a sealable opening containing a reinforcing olfactant for eliciting a positive response in the animal, a release control in communication with the supply reservoir for regulating release of the reinforcing olfactant, a delivery channel connected to the supply reservoir for delivering the reinforcing olfactant released from the supply reservoir; and a housing wherein the one or more supply reservoirs and the delivery channel are mounted so as to orient the reinforcing olfactant sufficiently proximate to the animal to thereby stimulate olfaction, while avoiding direct placement of the reinforcing olfactant on the animal so as to avoid habituation.

In preferred embodiments of the present invention, the reinforcing olfactant comprises an olfactory compound selected from the group consisting of: esters, linear terpenes, cyclic terpenes, aromatics, amines, alcohols, aldehydes, ketones, lactones, thiols, methylphosphine and dimethylphosphine, phosphine, zinc phosphide, diacetyl, acetoin, nerolin, substituted pyrazines, macrocycles, steroids, or any poly-nitro benzene derivative. Alternatively, the reinforcing olfactant may comprise an olfactory derivative including: an herbal extract, a food scent, a polypropylene extract, or a dermatologic extract.

Embodiments of the present invention employ pressurizing the reinforcing olfactant to a level greater than atmospheric pressure. Alternative embodiments may further include a delivery device in communication with the release control, wherein the delivery device is a dispenser selected from the group consisting of: a valve, an automated pump, a drip valve, a diffuser, a sprayer, an atomizer, or a particle dropper. Alternatively, the delivery device may be a dispenser for releasing the reinforcing olfactant according to a parameter selected from the group consisting of dose volume, flow rate, and interval.

A yet further feature of preferred embodiments comprises one or more sensors for detecting bioindicators of an animal's physiologic or psychological state electrically coupled to an analog device driver. This transmits corresponding digital data to a control processor programmed with instructions and data whereby actuation of a device driver regulating release of one or more of the plurality of reinforcing olfactants contained in the plurality of supply reservoirs in correspondence to a set of predetermined bioindicators. The present apparatus can also employ a pump or other delivery device for dispensing an olfactory stimulus, i.e., olfactant, to an animal. Examples of commercially available pumps adaptable to the present invention include, for example, micro electro-osmotic pump for liquids or a miniature vane pump for gas or air, to pressurize the reinforcing olfactant and thereby induce its flow through the sealable opening of the reinforcing olfactant. In alternative embodiments, the sealable opening may be fitted with an atomizer to disperse the olfactant.

The training device may further include a fastener for detachably securing the training apparatus of the delivery outlet sufficiently proximate to the animal to thereby stimulate olfaction, but avoiding direct application of a reinforcing olfactant to the fur, skin or other organ of an animal so as to avoid habituation. A wide variety of commercially available fastener mechanisms may be adapted for suitably securing the training apparatus, and may comprise a hook, a flexible hook and loop material, a clasp, clamp or other securing mechanism for detachably fastening the training device upon an animal's leash, collar, or other worn accessory. The training device may also be directly incorporated into an accessory. Alternatively, the training device may be attached to or held by the trainer or be placed anywhere near the animal.

Preferred embodiments of the electronic device may comprise a housing having a plurality of ports wherein a plurality of supply reservoirs are disposed. In a particularly preferred embodiment, the control processor employs multimodal switches and a device driver closing corresponding circuit loops to thereby activate a pump connected to a respective supply reservoir so as to induce flow of the respective reinforcing olfactant through a respective delivery channel. Particularly preferred embodiments further employ one or more sensors electrically coupled to the control processor. Each sensor is electrically coupled with an analog to digital converter which transmits corresponding digital date to electrically connected control processor programmed with a set of software instructions including algorithms corresponding to a bioindicator parameter detected by the sensor. In this particularly preferred embodiment, such software instructions and algorithms are provided in a computer storage medium configured for programmable processing of data and instructions wherein release of the reinforcing olfactant is automatically executed when a predetermined bioindicator parameter associated with a physiological state of the animal is sensed.

The control processor is thereby programmed to actuate a multimodal switch releasing a corresponding dose of the indicated reinforcing olfactant in accordance with the predetermined bioindicator parameter associated with a physiological state of the animal. Preferred embodiments may thus automatically regulate delivery of a reinforcing olfactant in accordance with an animal's physiologic state as detected by bioindicator sensors. For example, the reinforcing olfactant, lavender, would be automatically dispensed to attenuate anxiety, detected by bioindicators such as increased heart rate and respiration, and thereby calm the animal.

Further features of particularly preferred embodiments of the present invention include a remote control employing an antenna for transceiving wireless radio signals to thereby transmit trainer inputs or a set of software instructions embedded in such signals, and receiving radio signals containing data reflecting reinforcing olfactant levels, delivery and subject animal bioindicator parameters. Such a remote control can be a dedicated device or may be a programmed into another computing device, such as a computer, server, or smart phone, wirelessly connected to the training device of the present invention. Such embodiments further employ a GPS system for tracking an animal's location.

The present invention is further drawn to a method employing olfaction for training animals, including selecting a reinforcing olfactant, containing the reinforcing olfactant in a reservoir, releasing the reinforcing olfactant through a delivery channel so as to orient the reinforcing olfactant sufficiently proximate to the animal sufficiently proximate to the animal to thereby stimulate olfaction to thereby elicit a positive response, wherein the reinforcing olfactant is not directly administered to the surface of the animal so as to avoid habituation.

It is particularly preferred that the step of releasing the reinforcing olfactant elicits a reward, such as the scent of bacon for a dog behaving as desired. It is also preferred that in more advanced uses of the invention, that the step of releasing the reinforcing olfactant elicits a command response in the animal. That is, the olfaction acts as an autonomous command eliciting a positive response from the animal.

It is contemplated that the present invention provides an apparatus and method applicable to animals other than dogs and horses as specifically referred to above. For example, responsive animals commonly trained by man include monkeys, birds, mules, donkeys, llamas, alpacas, goats, dolphins, and other such animals. In addition, the present invention could be applied to a group of animals. For example, an olfactory stimulus to a barn of dairy cows may be employed to instill a calm mood to enhance milk production. While a number of exemplary aspects and embodiments have been discussed above, those possessed of skill in the relevant art will recognize certain modifications, permutations, additions and sub-combinations thereof which are embraced within the inventive scope of the present olfaction apparatus and method for training animals. It is therefore intended that the following appended claims are interpreted to include all such modifications, permutations, additions and sub-combinations as are within their true spirit and scope.

For clarification of terms describing features of the training system according to the present invention, as claimed herein, particular terms are defined below.

“Event loop” refers to a set of software instructions corresponding to a trainer or sensor input triggering a series of events, including selection of a reinforcing olfactant, setting a dosage, flow rate or interval for dispensing the selected olfactant, and producing verification of the delivery of the reinforcing olfactant, according to such software instructions.

“Olfaction” refers to a neurochemical response evoked when odors stimulate the brain cortex and amygdala.

“Reinforcing olfactant” refers to a gas, liquid, oil, solid or combination thereof, which exhibits olfactory or aromatic properties evoking olfaction capable of eliciting a behavior or mood.

“Positive response” refers to behavioral or mood conditioning which a reinforcing olfactant is designed to evoke, including without limitation, completion of a task, performance of a gait, posture or athletic endeavor, feat or trick, instilling a mood, disposition, or attenuating fear, anxiety or depression.

“Command response” refers to an olfactant autonomously evoking a behavioral or emotional response in an animal independent of a separate cue.

“Bioindicators” refers to observable or measurable parameters of neurological, biochemical, physiologic, auditory, gastronomic, biomechanical function indicative of an animal's physiologic state and may include vital signs, physiologic symptoms, physical movements or sounds detected by sensors of the present invention or by a trainer, such as, for example, heart rate, respiration, temperature, and movement of the animal.

### BRIEF DESCRIPTION OF DRAWINGS

FIG. 1 is a perspective view of a preferred embodiment of the training device according to the present invention.

FIG. 2 is a close up view of the preferred embodiment of FIG. 1.

FIG. 2A is a block diagram of a control unit component of FIG. 2.

FIG. 2B is a close up perspective view of the remote control unit of FIG. 1.

FIG. 3 is a block diagram showing sequential operational steps executed by a particularly preferred embodiment.

### DETAILED DESCRIPTION OF A PREFERRED EMBODIMENT

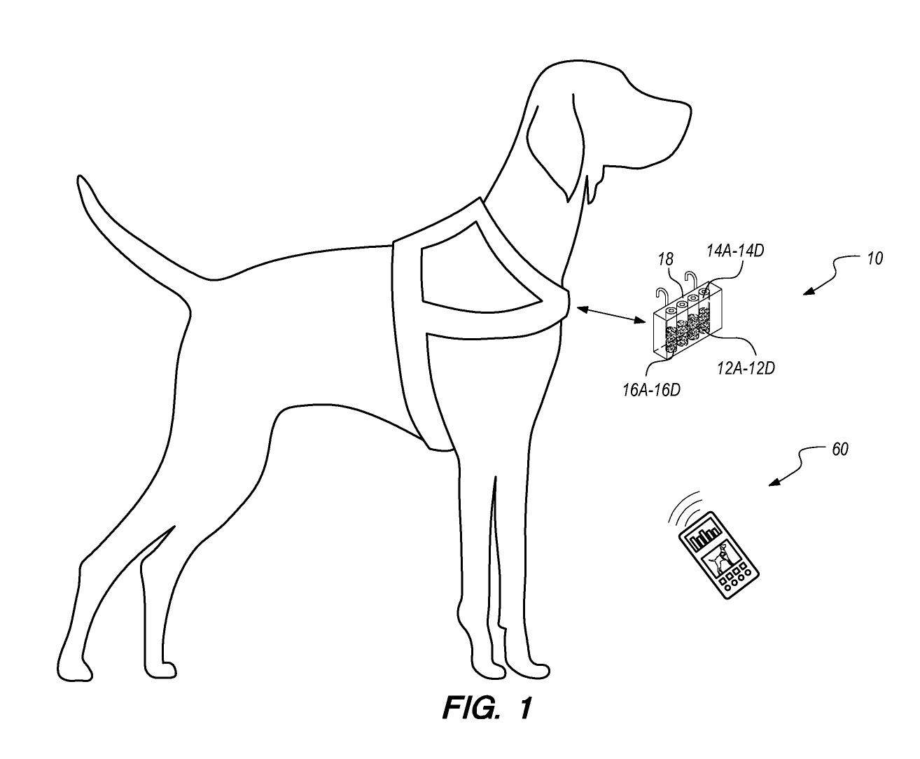

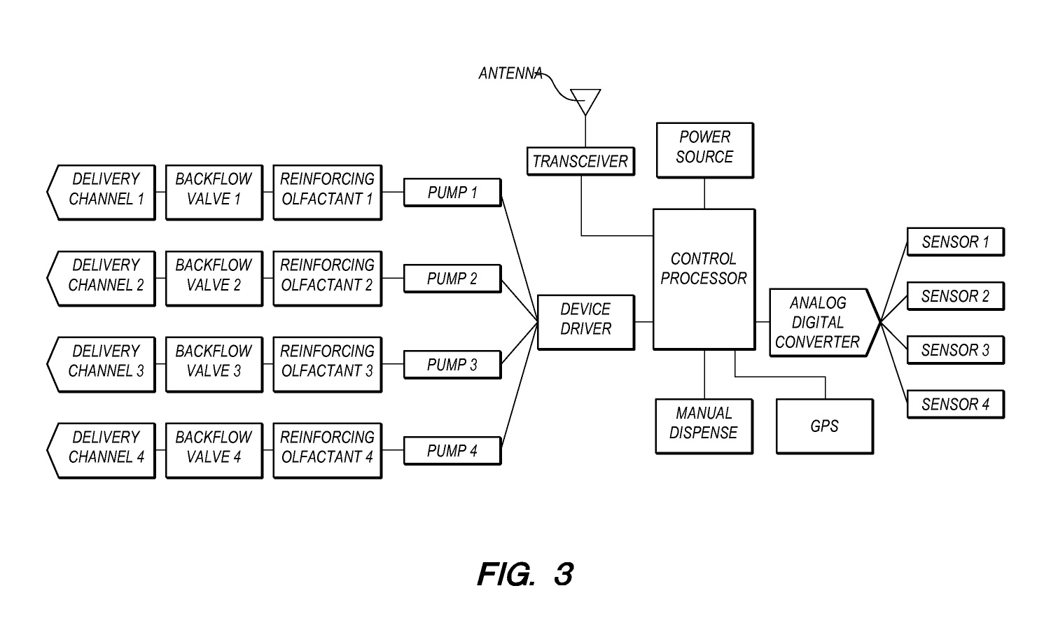

The present invention employs an innovative training apparatus and method employing olfactants as positive reinforcement to develop immediate associated voluntary and involuntary positive responses by a subject animal. FIGS. 1-3 depicts a preferred embodiment of the new training apparatus, whereby the method is deployed.

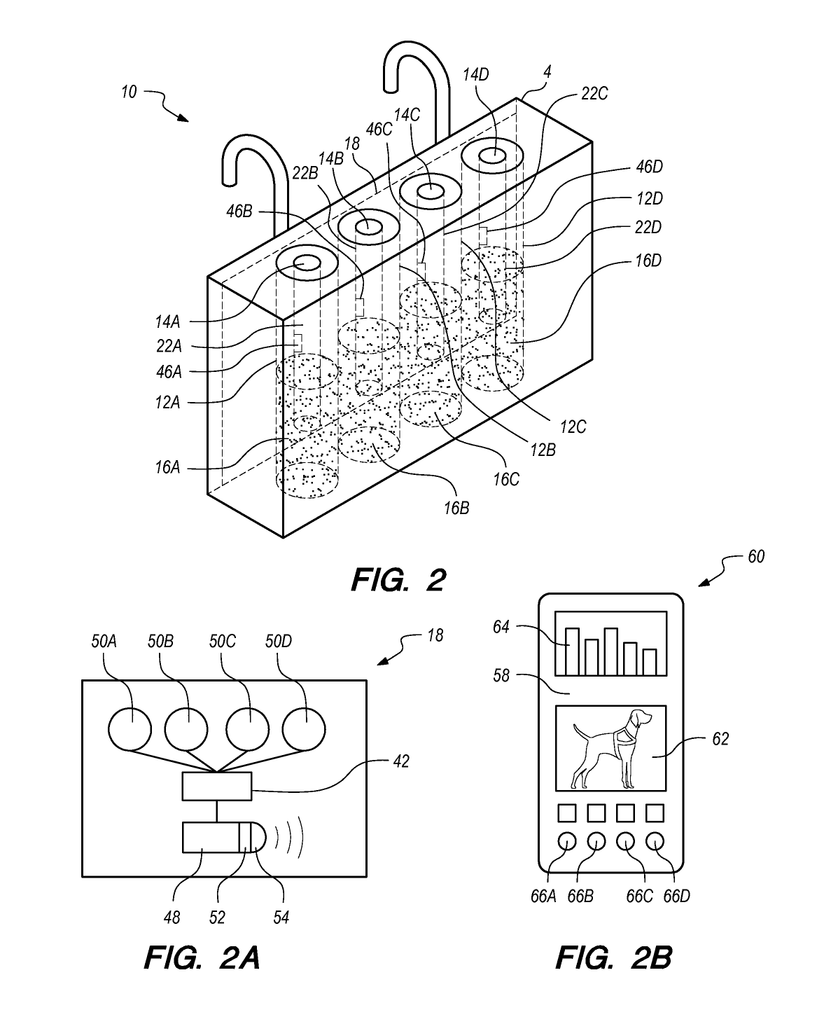

Referring to FIGS. 1-2, training apparatus 10 comprises a housing 4 wherein are disposed a plurality of supply reservoirs 12A, 12B, 12C, and 12D mounted in generally vertical alignment so as to orient sealable openings 14A, 14B, 14C, and 14D along an upper surface or housing 4. As shown in FIG. 1, housing 4 of this particular embodiment is provided with a fastener U hook for attaching training apparatus 10 to the frontal portion of a harness encircling an animal's neck and frontal torso. Thus positioning housing 4 to orient supply reservoirs 12A, 12B, 12C, and 12D proximately below the subject animal's olfactory glands optimizes stimulus via a gaseous or atomized carrier.

Supply reservoirs 12A, 12B, 12C, and 12D contain reinforcing olfactants 16A, 16B, 16C and 16D. In the present preferred embodiment 16A, 16B, 16C, and 16c respectively contain reinforcing olfactants lavender, cinnamon, rosemary and bacon scent. Olfactants employed in the present invention may comprise a wide variety of alternative scents derived from natural or synthetic compounds as defined above and be provided in an alternative compound configured as matter of any form, including solids, oils, liquids, gases, and combinations thereof, such as, for example, atomized liquids or a gel matrix. For example, the olfactant may be embedded in a gel or crystals in a manner so that air may be pumped over or through the solid matrix to then deliver the olfactant as a bolus of air, or the olfactant may be prepared as a liquid and pumped through an atomizer to be delivered as an atomized spray.

Training apparatus 10 has a dual mode dispensing mechanism enabling manual or automated dispensing of reinforcing olfactants 16A, 16B, 16C, and 16D. In manual mode, device driver 52 is actuated by a trainers' manual selection of an olfactant whereby device driver 52 is activated to open a corresponding one of sealable openings 14A, 14B, 14C, and 14D of a respective reinforcing olfactant 16A, 16B, 16C, and 16D whereby respective miniature pumps 46A, 46B, 46C, and 46D are activated to thereby dispense a gaseous scent exuding therefrom through delivery channels 22A, 22B, 22C, and 22D.

By repeatedly dispensing reinforcing olfactants 16A, 16B, 16C, and 16D at designated intervals to correlate with an exhibited positive response, a trainer thereby establishes an increasingly closer association between the selected olfactant and the positive response. Following repeated delivery of the olfactant in conjunction with the response, a selected on of the reinforcing olfactants 16A, 16B, 16C, and 16D elicits an impact of a command response from the animal immediately summoning the associated behavior or mood reinforcing olfactant, without requiring an auxiliary command through an additional non-olfactory, sense, e.g., sound, taste, sight, or touch.

An exemplary commercially available miniature pump adaptable for deployment in the illustrated embodiment includes, inter alia, a miniature vane pump for inducing air pressure for dispensing gaseous olfactants in an integrally streamlined configuration through the respective supply reservoir. In alternative embodiments employing liquids, such as sprays or atomizers, a micro-osmotic pump configured for dispensing such liquefied substances through an atomizer may be incorporated in a suitable design. Upon activation, control unit 18 actuates the respective pump to thereby dispense the selected reinforcing olfactant into the environment proximate to the animal.

Training apparatus 10 is further equipped with low level sensors affixed to critical points in supply reservoirs 12A, 12B, 12C, and 12D. Such low level sensors are connected to an auxiliary switch of device driver 52 whereby a pump 46A, 46B, 46C, or 46D is deactivated when any one of corresponding reinforcing olfactants 16A, 16B, 16C, and 16D drops below a threshold minimum level.

Now referring to the schematic breakout of control unit 18 shown FIG. 2A, taken in context of its connection to training apparatus 10 as shown in FIG. 2, automated dispensing of reinforcing olfactants 16A, 16B, 16C, and 16D is regulated by control unit 18 which includes sensors 50A, 50B, 50C, and 50D coupled with a release processor 48 containing programmable instructions for dispensing reinforcing olfactants 16A, 16B, 16C, and 16D according to detected parameters corresponding with bioindicators of an animal's physiologic state. In the illustrated embodiment, known, commercially available sensors are employed to derive analog measures of relevant parameters for measuring a corresponding bioindicators, which are converted to digital format by analog digital converter 42. Still referring to FIGS. 2-2A, sensors 50A-50D correspond to the following subject animal's bioindicators: 50A detects heart rate by an embedded noninvasive monitor, 50B detects temperature with a thermometer, 50C detects respiration and 50D detects location and movement speed with a GPS and accelerometer, of the subject animal. Alternative embodiments may employ sensors to detect any measurable bioindicator, including without limitation, levels of oxygen saturation or carbon dioxide, pH or other blood levels providing bioindicators by known diagnostic methods. A trainer may thereby select and dispense a reinforcing olfactant in accordance with a subject animal's physiologic or psychologic state, as well as, behavioral and mood objectives.

Still referring to FIGS. 1-3, a particularly preferred embodiment employs remote control 60 employing a transceiver and antennae (not shown) in communication with antennae 59 of training device 10 whereby remote monitoring and control of training apparatus 10. In the present embodiment, remote control 60 comprises an application provided in a trainer's mobile phone. In alternative embodiments, remote control functionality may utilize programmable processors and software applications installed in variously wirelessly connected components, including, for example, personal computers, networked servers or dedicated remote control units. According to the present embodiment, remote control 60 is programmed to process digitized data transmitted in signals received from antennae 59 so as to display on a graphical user interface (GUI) a graphic frame 64 depicting in vertical bars directly correlating to parameter levels detected by sensors 50A, 50B, 50C, and 50D.

Remote control 60 further enables a the trainer to dispense a selected one of reinforcing olfactants 16A, 16B, 16C, and 16D through touching or clicking one of the respective graphic images 66A, 66B, 66C, or 66D, which are preferably icons, on the GUI. A transceiver and antennae (not shown) of remote control 60 then transmits the trainer's selected command to a transceiver of training apparatus 10. Control processor 52 then processes the command to thereby actuate driver device 52 to dispense a respective one of reinforcing olfactants 16A, 16B, 16C, and 16D in accordance with the transmitted radio signal's instruction.

The GUI of remote control 60 further provides tracker frame 62 wherein data received from a GPS device, preferably embedded in sensor 50D, maps the subject animal's geographic location. A yet further feature of preferred embodiments of the present invention may include in remote control 60 GUI an olfactant low level graphic image to convey when a pump 46A, 46B, 46C, or 46D is deactivated due to a corresponding low level below a threshold detected by a respective low level sensor of the reinforcing olfactant.

Training apparatus 10 is insertable into an optional carrying case, which may be fastened to a trainer or animal. Alternatively, training apparatus 10 may be affixed to a post, fence or fixture or placed on any surface in the vicinity of an enclosure where an animal is located.

Alternative embodiments may further provide optional dispensing modes, including but not limited to, tubes, spray or atomizer nozzles with pipe ducts removeably insertable into supply reservoirs 12A, 12B, 12C, and 12D. As can be readily discerned, any mode of dispensing a reinforcing olfactant to thereby elicit a command response from an animal falls within the scope and spirit of the present invention.

The aforedescribed and alternative embodiments thereof enable employment of olfaction utilizing various methodologies. In particularly preferred methods employing the present invention, the olfactant may stimulate a natural or involuntary positive response in an animal. An example of a natural effect discussed above employs a lavender derivative, which calms many animals. This, or other scents that invoke an involuntary positive emotional state or mood, may be delivered by the trainer for the benefit of the animal or by the device as set by time intervals or by predetermined settings to release the olfactant in response to specific bioindicators as read by sensors.

In preliminary phases of training, release of an olfactant may be used as a reward positive reinforcement by the olfactant's natural effect. A trainer may tailor selection of the olfactant to an animal's natural propensity. One example of a natural propensity is deriving a scent from an animal's favorite food, such as bacon for many dogs. In this instance, the olfactant would be released immediately following the desired behavior, such as assuming a sitting posture after the verbal cue of “sit” from the trainer. In this manner, the olfactant serves as a replacement to an edible reward.

In further training the animal, to evoke a voluntary response, the olfactant would be delivered as a command to instill a specific behavior. During initial training, the animal may require frequent doses to instill a particular response. In addition to frequency, a trainer may simultaneously employ a command employing voice, touch or visual cues to instill the desired response. After the desired behavior is instilled in the animal, dosage level of the olfactant is incrementally reduced. Once the animal associates the olfactant with the desired response, the trained animal will develop a reflex response to minimal release of the olfactant without secondary vocal, tactile or visual cueing. Intermittent release of minimal doses combined with avoidance of direct olfactant to animal contact thus avoids desensitization resulting from habituation. An example of employing both reward and stimulus would be using the scent of chicken accompanied with the trainer calling the animal to their side and rewarded upon return. Over time, the scent would be used in isolation without calling for the animal, and the scent could then be used as a command from great distances to beckon the animal to return to the trainer. Selections of more “neutral” olfactants, without known propensities or natural effects, are also efficaciously employed. Examples of such olfactants include parsley and verbena. Use of more random and especially unfamiliar olfactants provides the trainer flexibility in training an animal to perform particular acts, postures or gaits at a higher level, such as expected in shows, races, obstacle courses or other tasks.

The above detailed description of preferred embodiments provides exemplary models for the animal training system according to the present invention. It can be readily seen by one skilled in the art that alternative combinations and permutations of training systems employing olfactants to condition, modify or command animal behavior or mood would fall within the scope and spirit of the present invention, as described and claimed herein.

1. A training apparatus for delivering an olfactory stimulus to an animal, comprising:
at least one supply reservoir having a sealable opening, wherein the at least on supply reservoir contains a reinforcing olfactant for eliciting a positive response in the animal;
a release control in communication with the supply reservoir for regulating release of the reinforcing olfactant;
a delivery channel connected to the supply reservoir for delivering the reinforcing olfactant released from the supply reservoir; and
a housing wherein the at least one supply reservoir and the delivery channel are mounted so as to orient the reinforcing olfactant sufficiently proximate to the animal to thereby stimulate olfaction, wherein the reinforcing olfactant is not directly administered to the animal so as to minimize habituation.

2. The training apparatus of claim 1, wherein the reinforcing olfactant comprises a compound selected from the group consisting of: esters, linear terpenes, cyclic terpenes, aromatics, amines, alcohols, aldehydes, ketones, lactones, thiols, methylphosphine and dimethylphosphine, phosphine, zinc phosphide, diacetyl, acetoin, nerolin, substituted pyrazines, macrocycles, steroids, or any poly-nitro benzene derivative.

3. The training apparatus of claim 1, wherein the reinforcing olfactant comprises an olfactory derivative selected from the group consisting of:
an herbal extract,
a food scent,
a polypropylene extract,
a dermatologic extract.

4. The training apparatus of claim 1, wherein the at least one supply reservoir contains a reinforcing olfactant pressurized to a level greater than atmospheric pressure.

5. The training apparatus of claim 1, wherein the at least one supply reservoir comprises a plurality of supply reservoirs, and wherein the release control further comprises a valve bobbin, wherein the valve bobbin has a channel for releasing the reinforcing olfactant to the delivery channel when the valve bobbin is rotated to align the channel so as to open the sealable opening of the corresponding supply reservoirs.

6. The training apparatus of claim 1, further comprising a delivery device in communication with the release control, wherein the delivery device is a dispenser selected from the group consisting of: a valve, an automated pump, a drip valve, a diffuser, a sprayer, an atomizer, or a particle dropper.

7. The training apparatus of claim 1, further comprising a delivery device in communication with the release control, wherein the delivery device is a dispenser for releasing the reinforcing olfactant according to a parameter selected from the group consisting of dose, volume, flow rate, and interval.

8. The training apparatus of claim 1, wherein the at least one supply reservoir comprises a plurality of supply reservoirs and the release control further comprises a sensor electrically connected to a switch, wherein the switch closes a circuit loop activating release of one or more of the plurality of reinforcing olfactants contained in the plurality of supply reservoirs in correspondence to a set of predetermined bioindicators associated with the physiologic state of the animal detected by the sensor.

9. An electronic training device for delivering an olfactory stimulus to an animal, comprising:
a housing wherein at least one supply reservoir with a sealable opening for containing a reinforcing olfactant is mounted;
at least one delivery channel connected to the supply reservoir for releasing the reinforcing olfactant;
a control processor having a computer storage medium configured for programmable processing of data and instructions for controlling the portion of the reinforcing olfactant dispensed; and
a device driver electrically connected to the control processor, and coupled to the one or more delivery channels so as to actuate dispensing of the reinforcing olfactant through the sealable opening.

10. The electronic training device of claim 9, wherein the at least one supply reservoir comprises a plurality of supply reservoirs disposed within a corresponding plurality of ports, wherein each of the plurality of supply reservoirs is coupled with a corresponding pump such that the device driver actuates a corresponding pump to thereby pressurize one or more reinforcing olfactants from a corresponding one or more of the plurality of supply reservoirs.

11. The electronic training device of claim 9, wherein the device driver releases the reinforcing olfactant according to a parameter selected from the group consisting of dose, volume, flow rate, and interval.

12. The electronic training device of claim 9, further comprising:
a sensor for detecting a predetermined bioindicator parameter; and
an analog digital converter coupled to the sensor, wherein the analog digital converter translates the predetermined bioindicator parameter into a digital format transmitted to the control processor.

13. The electronic training device of claim 9, further comprising an antenna for transceiving wireless signals for remotely communicating with the electronic device.

14. The electronic training device of claim 9, further comprising a computer storage medium configured for remote programmable processing of data and instructions, whereby the control processor is remotely adjustable.

15. A method for training an animal with silent commands, comprising:
selecting a reinforcing olfactant comprising an olfactory compound selected from the group consisting of: esters, linear terpenes, cyclic terpenes, aromatics, amines, alcohols, aldehydes, ketones, lactones, thiols, methylphosphine and dimethylphosphine, phosphine, zinc phosphide, diacetyl, acetoin, nerolin, substituted pyrazines, macrocycles, steroids, or any poly-nitro benzene derivative;
containing the reinforcing olfactant in a reservoir; and
releasing the reinforcing olfactant through a delivery channel so as to orient the reinforcing olfactant sufficiently proximate to the animal sufficiently proximate to the animal to thereby stimulate olfaction to thereby elicit a positive response, wherein the reinforcing olfactant is not directly administered to the animal so as to minimize habituation.

16. The method of claim 15, wherein the step of releasing the reinforcing olfactant elicits a command response in the animal.

17. The method of claim 15, further comprising sensing a physiologic state of the animal manifested by a bioindicator selected from the group consisting of heart rate, respirations, blood pressure, body temperature, sound, and physical movement.

18. A computer storage medium configured for programmable processing of data and instructions for execution of the method of claim 17, wherein the step of releasing the reinforcing olfactant is automatically executed when a predetermined bioindicators associated with a physiological state of the animal is sensed.

19. A computer storage medium configured for programmable processing of data and instructions for implementing the method of claim 17, further comprising the step of releasing the reinforcing olfactant is adjustable in correspondence to sensing predetermined bioindicators associated with a physiological state of the animal.

20. The method of claim 19, further comprising remotely dispatching instructions via a radio signal.
